(19) United States
(12) Patent Application Publication
(10) Pub. No.: US 2026/0344656 A1
(43) Pub. Date: Nov. 5, 2026

(54) Miniaturized Portable Hyperbaric Oxygen Chamber

(71) Applicants: Matthew Rodrigo Endara, Spring Hill, TN (US); Jason R. Cordova, Franklin, TN (US)

(72) Inventors: Matthew Rodrigo Endara, Spring Hill, TN (US); Jason R. Cordova, Franklin, TN (US)

(21) Appl. No.: 19/663,287

(22) Filed: Apr. 30, 2026

Related U.S. Application Data
(60) Provisional application No. 63/798,032, filed on May 1, 2025.

(51) Int. Cl. A01N 1/142

(52) U.S. Cl. CPC A01N 1/142

(57) ABSTRACT

A miniaturized portable hyperbaric oxygen chamber is disclosed and is designed for hyper-oxygenating tissues for purposes of treating tissue and other biological materials. The tissue and other biological materials may then be used in wound healing, cosmetic procedures, or in any other suitable medical setting. The miniaturized hyperbaric oxygen chamber is portable, provides enhanced safety, ease of use, facilitates tissue transplantation, and operational efficiency within medical and cosmetic environments. Additionally, methods for manufacturing and utilizing this compact hyperbaric oxygen chamber are described.

### CROSS-REFERENCE TO RELATED APPLICATIONS

This application claims priority to U.S. Provisional Patent Application having Ser. No. 63/798,032, filed on May 1, 2025, the entire disclosure of which is hereby incorporated herein by reference.

### BACKGROUND

Hyperbaric oxygen therapy (HBOT) is a well-established medical treatment utilizing controlled increased atmospheric pressure to enhance oxygen delivery to bodily tissues. Traditional hyperbaric chambers are substantial in size, posing significant limitations in terms of portability and adaptability for various clinical settings. These large apparatuses are typically confined to specialized facilities, which restricts their accessibility for point-of-care treatments and diminishes flexibility in medical and cosmetic applications. Moreover, the size and complexity of typical hyperbaric chambers often lead to significant cost and logistic barriers in delivering timely therapeutic interventions. Of note, these hyperbaric chambers are designed for full organism hyperoxygenation rather than oxygenation of tissues such as a tissue that was immediately removed including, but not limited to, grafts, flaps, organs, and acellular matrix products designed to retain oxygenation

Existing hyperbaric chambers also have been associated with safety concerns, predominantly due to the high oxygen concentration environments they generate. These conditions impose a risk of potential oxygen toxicity and fire hazards, thus necessitating rigorous operational protocols and specialized training for personnel. Furthermore, traditional systems often involve cumbersome processes for sterilization, which are both labor-intensive and time-consuming, consequently reducing throughput and increasing downtime between uses. This limitation can impede prompt accessibility for treatments, compromising therapeutic efficacy, especially in urgent medical scenarios.

Current techniques in HBOT lack efficient mechanisms for preventing cross-contamination, a critical consideration in medical environments. This shortfall is compounded by the lack of single-use solutions that ensure sterility without necessitating extensive cleaning regimens. Additionally, traditional chambers offer limited flexibility in terms of adjunct therapeutic modalities that could further enhance tissue oxygenation, such as the use of oxygen-dissolving support fluids known for improving oxygen retention in tissues, which are rarely integrated into standard operating procedures.

What is needed is a miniaturized system capable of delivering hyperbaric oxygen therapy in a manner that overcomes current size, safety, and sterility limitations. Such a system would enable increased portability and immediate deployment in varied medical settings, offering targeted treatments with enhanced safety protocols. Ideally, the system would also integrate single-use systems for sterility, thereby reducing cross-contamination risks without elaborate post-treatment cleaning. Additionally, incorporating supplemental oxygenation methods with support fluids would bolster therapeutic efficacy by prolonging oxygen retention within tissues, thus addressing the limitations of traditional HBOT systems. Flexibility in use is another desirable feature of a miniaturized system. In particular, it would be desirable if the system is capable of being used in settings where oxygen is available, such as in the hospital, or in settings where oxygen is not available but may be supplied by oxygen tanks or canisters.

### FIELD

The described technology relates to the field of medical devices, specifically focusing on miniaturized hyperbaric oxygen chambers intended for hyper-oxygenating tissues, wherein the tissue is outside of the body in preparation for transplantation. The applications of this technology may extend to wound healing, tissue transplantation, and cosmetic procedures. The miniaturized hyperbaric oxygen chamber has increased portability, enhanced safety, and operational efficiency within medical and cosmetic environments.

### DESCRIPTION OF THE PRIOR ART

Hyperbaric oxygen therapy (HBOT) is a recognized medical treatment that provides pure oxygen in a pressurized environment. This is typically done within large chambers wherein the patient enters the chamber. The chamber then provides hyperbaric oxygen to increase oxygen solubility in blood plasma and tissues. This therapy is utilized prominently for promoting wound healing, combating infections, and enhancing recovery in complex surgical procedures. Despite its efficacy, conventional hyperbaric chambers are characterized by their substantial size and fixed installation, confining their application to settings with significant spatial and infrastructural resources, such as hospitals or specialized medical centers. Consequently, this limits accessibility for on-site medical interventions or therapies requiring flexible deployment.

The current landscape of hyperbaric oxygen therapy technology faces several limitations that curb its broader clinical application. Standard hyperbaric chambers are notably large and immobile, prohibiting their use in diverse medical or cosmetic settings that require point-of-care treatment. The sheer size and the structural requirements for operation also entail considerable costs in terms of infrastructure and maintenance, which can be prohibitive for smaller medical practices or outpatient care facilities. Safety concerns associated with high-pressure oxygen environments further complicate the widespread adoption of these devices, as strict protocols and trained personnel may be necessary to mitigate risks like oxygen toxicity and fire hazards.

Moreover, traditional hyperbaric chambers often involve intricate operation and post-use sterilization processes, posing significant logistical challenges for frequent or expedient usage. The sterility concerns associated with reusable chambers necessitate meticulous cleaning regimens to prevent cross-contamination, particularly critical in medical settings where infection control is paramount. Additionally, the inability to facilitate localized treatment restricts the chambers' relevance for targeted therapies such as tissue transplantation, fat grafting, and similar procedures that would benefit from enhanced oxygen delivery at specific sites.

What is needed is a solution that provides the therapeutic benefits of hyperbaric oxygen therapy while overcoming the limitations of size, portability, and operational complexity inherent in existing technologies. A miniaturized system capable of delivering localized, high-concentration oxygen therapy with enhanced safety features would address the spatial and logistical barriers, offering a more accessible and flexible option for both medical and cosmetic applications. Such a development must ensure sterility, incorporate robust safety mechanisms, and support versatile application across various tissue treatment procedures.

Even in some cases where miniaturized systems may be available, these systems do not focus on ease of use, portability or safety. In particular, some systems may be dual chambered, but the chambers are not nested and do not provide any safety features.

### SUMMARY

In one aspect, the present disclosure pertains to a miniaturized hyperbaric oxygen chamber designed to enhance the delivery of oxygen to tissues, thereby facilitating processes such as wound healing and tissue transplantation. The chamber's compact design permits easy transport and operation in diverse settings, expanding its applicability in medical and cosmetic environments.

One objective of the disclosure is to improve the efficiency of hyperbaric oxygen therapy by providing a portable solution that increases the accessibility of treatment directly at the point of care when full organismal treatment is not needed. This aspect of portability underscores the chamber's suitability for immediate use in clinical and cosmetic procedures, reducing the logistical complexities often associated with traditional hyperbaric chambers.

In another aspect, the chamber employs advanced safety features through a dual-chamber system. This design reduces the risks posed by high oxygen concentrations, a known issue in hyperbaric oxygen therapy. The system also maintains a self-contained environment, minimizing external contamination, and ensuring a consistent safety protocol during operation. Further, the system includes flashback arrestors to prevent flames from traveling back into hoses, regulators, and gas cylinders. This feature prevents any possible catastrophic explosions. The flashback arrestors works by stopping reverse oxygen flow and is capable of extinguishing flashbacks. The flashback arrestor cuts off gas or oxygen to the unit in the event that the unit overheats, thereby protecting both equipment and users.

Another objective of the invention is to provide a sterile environment for each use. This may be achieved through a single-use internal chamber with a liner. This feature eliminates cross-contamination risks and enhances the chamber's suitability for sensitive medical applications, as it does not require comprehensive sterilization post-use. Alternatively, the internal chamber may include trays that are disposable or capable of being sterilized for reuse.

In an embodiment, the chamber may use support fluids containing oxygen-dissolving substances, such as carbon perfluorocarbons, to optimize the oxygenation process. This method facilitates the transfer of oxygen to tissues. Dimethylsulfoxide may be used to prolong oxygen retention by neutralizing free radicals, thus optimizing tissue viability.

In yet another aspect, the chamber demonstrates application versatility across a wide range of procedures, including cosmetic treatments, fat grafting, skin grafting, bone marrow treatment, and organ transplantation. It potentially improves tissue survival rates, decreasing the likelihood of repeated surgical interventions and resulting in enhanced clinical outcomes.

Yet another object of the invention is to integrate additional features, such as an opaque design and fail-safe mechanisms, which contribute to privacy and security during operations. These characteristics further promote the chamber's utility in clinical and cosmetic settings by ensuring a safe and controlled environment for the administration of hyperbaric oxygen therapy.

### BRIEF DESCRIPTION OF THE DRAWINGS

FIG. 1 shows a perspective view of a hyperbaric apparatus including a pressure vessel housing and associated gas supply options (wall hook up or oxygen canisters) and compression components.

FIG. 2 shows a perspective view of a hyperbaric chamber pressure vessel including an outer housing, an inner housing, support feet, an auxiliary oxygen tank recess, and a handle.

FIG. 3 shows a perspective view of a hyperbaric chamber assembly including an outer pressure vessel housing, an inner vessel housing, a compression component chamber, and support feet.

FIG. 4 shows a perspective view of a hyperbaric chamber having a pressure vessel housing with a structural door, a control panel, and internal grooved tracks configured to receive storage trays.

FIG. 5 shows a perspective view of a hyperbaric chamber with a hinged door in an open position, illustrating a compression-actuated latching arrangement and associated sealing interface.

FIG. 6 shows a perspective view of a hyperbaric chamber with an open door and storage trays configured to slide within grooved tracks in an interior space.

FIG. 7 shows a perspective view of a hyperbaric chamber with a door in an open position and with grooved tracks configured to slidably receive one or more removable storage trays.

FIG. 8 shows a perspective view of a hyperbaric chamber with the door in an open position and illustrating multiple grooved tracks disposed along opposing sidewalls of an interior space for receiving a removable storage tray.

FIG. 9 shows a perspective view of a hyperbaric apparatus including a high-pressure oxygen inlet port capable of connecting to standard hospital-supplied oxygen.

FIG. 10 shows a perspective view of a hyperbaric apparatus coupled to auxiliary oxygen tanks demonstrating the different options for delivering high pressure oxygen to the internal chamber.

FIG. 11 shows a schematic view of a hinge assembly.

FIG. 12 shows a schematic view of a compression-actuated latching mechanism for a hyperbaric chamber door.

FIG. 13 shows a schematic view of a compression-actuated latching mechanism for a hyperbaric chamber.

FIG. 14 shows a perspective view of a hyperbaric chamber door assembly including a structural door, a translucent panel, and a compression-actuated latching mechanism.

FIG. 15 shows a side view of a U-shaped bar and a corresponding recess configured to receive the bar.

FIG. 16 shows a perspective view of a hyperbaric chamber including a pressure vessel and a door assembly.

### DETAILED DESCRIPTION

### LIST OF COMPONENTS

Hyperbaric apparatus 10
Pressure vessel housing 12
Vessel support 13
Primary access opening 14
Support feet 15
Auxiliary oxygen tank 17
Auxiliary oxygen tank recess 18
Handle 20
Control panel 22
Structural door 25
Translucent panel 28
Hinge assembly 30
Central barrel 32
Hinge attachment leaves 33
Fasteners 34
Compression-actuated latching mechanism 35
U-bar 37
U-bar recess 38
Gasket 40
Gasket recess 45
Inner vessel housing 50
Compression component chamber 55
Hyperbaric chamber 60
Secondary access opening 61
First grooved tracks 62
First storage tray 63
First storage tray rails 64
Second grooved tracks 66
Second storage tray 67
Second storage tray rails 68
Compressor 70
Distribution manifold 75
Condensate drain line 78
Inlet manifold 80
High pressure oxygen inlet port 82
Bulkhead fitting 85
Hose adaptor 88
First hose 90
Second hose 92
Hose connector 94

In one embodiment, a hyperbaric apparatus 10 is disclosed comprising a pressure vessel housing 12 which defines a compression component chamber 55 and an inner vessel housing 50 which defines a hyperbaric chamber 60. Of note, the apparatus has two chambers configured in a nesting fashion.

In a preferred embodiment, the pressure vessel housing 12 is made of any suitable rigid plastic and is formed by a casting process. Rigid plastics that may be suitable for forming one or more portions of pressure vessel housing 12 and/or inner vessel housing 50 and/or the storage trays, include, but are not limited to, polycarbonate (PC), acrylonitrile butadiene styrene (ABS), polycarbonate/ABS blends (PC/ABS), Polysulfone (PSU), Polyphenylsulfone (PPSU), polyethersulfone (PES), polyetherimide (PEI), polyaryletherketone materials, including polyether ether ketone (PEEK) and polyether ketone ketone (PEKK), polyamide materials (PA), including PA6 and PA66 (including glass-filled variants), Polyoxymethylene (POM) (acetal), polyethylene terephthalate (PET), polybutylene terephthalate (PBT), polyethylene (PE), including high-density polyethylene (HDPE) and ultra-high-molecular-weight polyethylene (UHMWPE), Polypropylene (PP) (including glass-filled variants), polyvinyl chloride (PVC) (rigid PVC), polyvinylidene fluoride (PVDF), polyphenylene sulfide (PPS), liquid crystal polymer (LCP), poly(methyl methacrylate) (PMMA), styrene acrylonitrile (SAN), polycarbonate copolymers and impact-modified polycarbonate formulations, and fiber-reinforced polymer composites using thermoplastic matrices (e.g., glass-fiber-reinforced PP, glass-fiber-reinforced PA, glass-fiber-reinforced PBT, carbon-fiber-reinforced PEEK).

In preferred embodiments, support feet 15 are made of silicon or any other suitable material. In particular, the base of the hyperbaric apparatus 10 includes a plurality of longitudinal support feet 15 (embodied as rails) configured to provide a stable resting surface.

In one embodiment, auxiliary oxygen tank recess 18 is configured in a vertical shape, while in other embodiments, auxiliary oxygen tank recess 18 is configured in a horizontal shape.

In preferred embodiments, pressure vessel housing 12 includes a handle 20 and a control panel 22. In preferred embodiments, control panel 22 is an LED control panel. The control panel allows the user to set the oxygen concentration and pressure in the chamber. Information on the amount of oxygen in the hyperbaric chamber 60 is obtained by allowing small amounts of internal gas out of the chamber in metered amounts into a separate or secondary chamber which then measures the oxygen and pressure and delivers that information to the control panel. This is an additional safety measure as it is the release of the gas into a safe secondary chamber where measurements are made as opposed to in the hyperbaric chamber 60 itself.

In further detail, the oxygen concentration and pressure are measured by releasing small amounts of oxygen from the hyperbaric chamber 60 into a secondary chamber for sampling and then released into the air. Software contained within control panel 22 includes logic capable of auto-calibrating and adjusting the delivery of oxygen into the hyperbaric chamber 60 to the desired oxygen concentration and oxygen pressure. In some embodiments, the secondary chamber is the compression component chamber 55.

In a preferred embodiment, structural door 25 is made of polycarbonate which is made by a casting process. Translucent panel 28 is made of clear polycarbonate, which is also made by a casting process. In less preferred embodiments, any other suitable material may be used.

In another preferred embodiment, hinge assembly 30 includes a central barrel 32 and a plurality of hinge attachment leaves 33 extending laterally therefrom, wherein the hinge attachment leaves 33 are secured to the pressure vessel housing 12 via a plurality of fasteners 34.

In another preferred embodiment, a u-bar 37 is included on structural door 25 and when the door is closed, the u-bar 37 is received by u-bar recess 38, which is located within one vertical side frame of pressure vessel housing 12. The structural door 25 is then sealed shut by way of a compression-actuated latching mechanism 35 also located on one vertical side frame of pressure vessel housing 12.

Because a tight seal is required between the pressure vessel housing 12, the structural door 25 preferably defines a circumferential gasket recess 45, preferably made of rubber, on the interior side of the door and is configured to receive a gasket 40, thereby providing a tight seal between structural door 25 and pressure vessel housing 12.

In preferred embodiments, a nested inner vessel housing 50 is included within pressure vessel housing 12, thereby defining a compression component chamber 55 and a hyperbaric chamber 60. Pressure vessel housing 12 and Inner vessel housing 50 are connected by vessel support 13 which is configured as a perimeter panel between the two housings and allows the inner vessel housing 50 to almost float within pressure vessel housing 12, while also defining compression component chamber 55.

In preferred embodiments, the pressure vessel housing 12 defines a first aperture or primary access opening 14, and the inner vessel housing 50 defines a second aperture or secondary access opening 61, wherein the first and second apertures are substantially coextensive to allow access to the interior of the hyperbaric chamber 60.

In further embodiments, the hyperbaric apparatus 10 has a width of 250 mm, a height of 245 mm, and a depth of 245 mm and the hyperbaric chamber has a width of 210 mm, a height of 206 mm, and a depth of 205 mm. These dimensions are provided as an illustrative example only. It is understood that other measurements may be suitable and are included within the spirit of this disclosure.

Preferably, the interior of hyperbaric chamber 60 includes a pair of first grooved tracks 62 located towards the bottom and on either side, configured to slidably engage with first storage tray rails 64, which support a first storage tray 63 and a pair of second grooved tracks 66 located towards the top and on either side, configured to slidably engage with second storage tray rails 68, which support a second storage tray 67.

In some embodiments, the adipose (fat) tissue is held in the first storage tray 63 or the second storage tray 67. In some embodiments, hyperbaric chamber 60 is configured to receive, store, and hyper-oxygenate one or more biological materials other than adipose (fat) tissue. By way of example, the biological material may include one or more of:

Skin tissue, including split-thickness skin grafts and full-thickness skin grafts. Dermal substitutes and dermal matrices, including acellular dermal matrices. Fascia, including fascia and other connective tissue sheets. Cartilage tissue, including auricular cartilage, nasal cartilage, and costal cartilage segments. Tendon tissue, including autograft or allograft tendon segments. Ligament tissue, including ligament graft segments. Bone tissue, including cortical bone segments, cancellous bone chips, and bone blocks. Bone marrow and bone marrow aspirate, including concentrates or mixtures with carrier media. Vascular tissue, including vein graft segments and arterial graft segments. Nerve tissue, including peripheral nerve graft segments. Muscle tissue, including small muscle graft segments. Amniotic tissue products, including amnion and chorion sheets. Placental-derived tissue products. Corneal tissue and scleral tissue segments. Dental tissues, including periodontal ligament-containing graft materials and dental pulp-derived tissues. Composite grafts, including combinations of skin, cartilage, and subcutaneous tissue. Microvascular free-flap tissue segments and flap components during preparation prior to implantation. Biopsy specimens and explanted tissue intended for later re-implantation. Cellularized constructs and tissue-engineered grafts, including scaffold-based constructs seeded with cells. Organotypic slices and small organ segments, including segments of liver, kidney, pancreas, or myocardium for research, preclinical use, or transplant preparation workflows where permitted.

In some embodiments, the foregoing biological materials may be placed on first storage tray 63 and/or second storage tray 67 for processing within hyperbaric chamber 60, including embodiments in which one of the trays is configured as a disposable sterile interface and another tray is configured to be permanent and is attached to the hyperbaric apparatus 10 for repeated use.

In further embodiments, a solution may be included with the adipose (fat) tissue or other biological material during processing. The solution is designed to assist stem cell survival. While additional stem cells may be added, they are already present within the adipose (fat) tissue or biological material and thus stem cells do not need to be added separately.

In some embodiments, a compressor 70 is used, while in other embodiments, the hyperbaric pressure is created by the supply of oxygen into hyperbaric chamber 60 on its own. Compressor 70 is in fluid communication with distribution manifold 75, which is in fluid communication with the interior of hyperbaric chamber 60. Condensate drain line 78 is capable of removing condensate from hyperbaric apparatus 10.

In other preferred embodiments, an inlet manifold 80 is located within the compression component chamber 55 and is in fluid communication with the inside of hyperbaric chamber 60 and high pressure oxygen inlet port 82, which is connected to bulkhead 85, and hose adaptor 88. In some embodiments, hose adaptor is connected ti a first hose 90 and a second hose 92, which are connected by way of hose connector 94.

In a preferred embodiment, flashback arrestors may be used to prevent a spark from causing a fire. The flashback arrestors may be located in the hyperbaric chamber 60 and one may be adapted to the auxiliary oxygen tank 17. These safety features are particularly important because of the miniaturized size of the apparatus.

In some embodiments, the hyperbaric apparatus 10 may be powered by a power cord or by a battery.

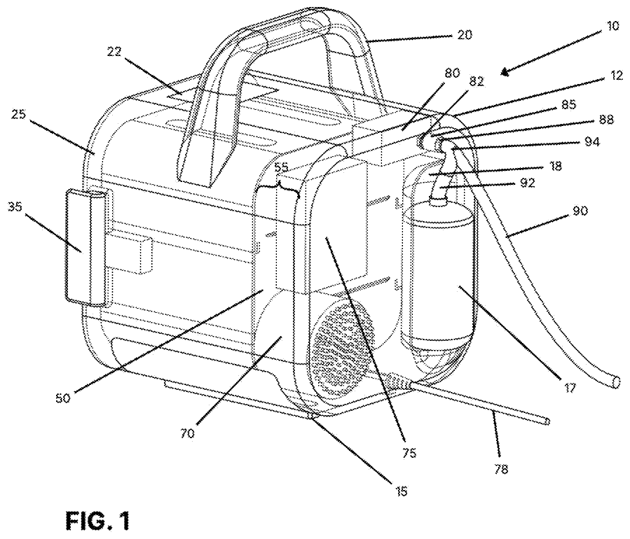

Turning to the figures, FIG. 1 shows a hyperbaric apparatus 10 including a pressure vessel housing 12 supported by support feet 15. The pressure vessel housing 12 is coupled to a handle 20 to facilitate transport and/or positioning of the hyperbaric apparatus 10. A control panel 22 is disposed on an exterior portion of the pressure vessel housing 12 and may be configured to receive user inputs and to display operating parameters. The pressure vessel housing 12 includes a structural door 25 providing access to an interior volume defined by an inner vessel housing 50. The structural door 25 is shown as optically transparent and may be formed from a polymeric sheet material such as clear polycarbonate, acrylic (PMMA), PETG, polyurethane, or a multilayer laminate including one or more polymer layers and/or reinforcement layers. The structural door 25 is retained in a closed configuration by a compression-actuated latching mechanism 35 that applies a compressive retention force to maintain a pressure boundary during operation.

FIG. 1 further depicts a compression component chamber 55 coupled to the pressure vessel housing 12 and optionally containing a compressor 70 and a distribution manifold 75. The compressor 70 may be configured to pressurize process gas for delivery via the distribution manifold 75 to the inner vessel housing 50. The distribution manifold 75 may include one or more components providing filtration, moisture removal, and heat exchange capability. The distribution manifold 75 is in communication with a condensate drain line 78 configured to drain and/or purge condensate from the distribution manifold 75.

FIG. 1 further depicts an inlet manifold 80 coupled to the pressure vessel housing 12 and in fluid communication with the inner vessel housing 50. The inlet manifold 80 is supplied via a high pressure oxygen inlet port 82. The high pressure oxygen inlet port 82 is coupled through a bulkhead fitting 85 and a hose adaptor 88. A first hose 90 is coupled to the hose adaptor 88 via a hose connector 94 and may couple the hyperbaric apparatus 10 to an external high-pressure oxygen source. The pressure vessel housing 12 further includes an auxiliary oxygen tank recess 18 configured to receive an auxiliary oxygen tank 17, with the auxiliary oxygen tank 17 fluidly coupled to the high pressure oxygen inlet port 82 via a second hose 92.

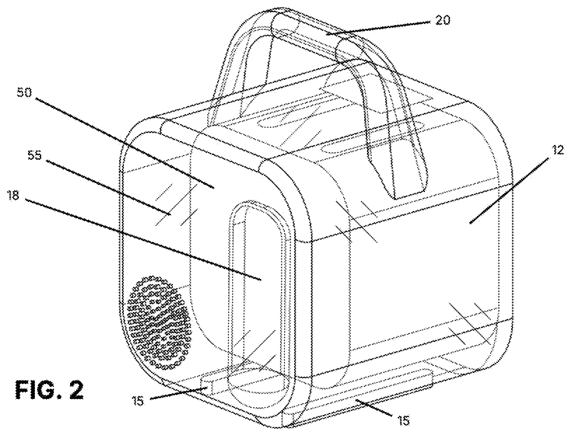

FIG. 2 shows a hyperbaric chamber pressure vessel housing 12 defining an outer enclosure and supporting an inner vessel housing 50. The pressure vessel housing 12 may provide a pressure-retaining structure surrounding an interior space bounded by the inner vessel housing 50. A handle 20 is coupled to an upper portion of the pressure vessel housing 12 to facilitate carrying, repositioning, and/or installation of the chamber.

As shown in FIG. 2, the pressure vessel housing 12 includes support feet 15 disposed along a lower portion of the housing to support the chamber on a surface and to provide clearance beneath the housing. The pressure vessel housing 12 further includes an auxiliary oxygen tank recess 18 configured to receive an auxiliary oxygen canister or tank, with the recess 18 being formed in a side or rear region of the housing to accommodate a canister profile while maintaining an outer envelope of the pressure vessel housing 12.

FIG. 2 further depicts a compression component chamber 55 arranged within the pressure vessel housing 12 and adjacent to the inner vessel housing 50. The compression component chamber 55 may house pressure-generation and/or gas-conditioning components (including, in some configurations, a compressor and a distribution manifold) in a volume separated from the inner vessel housing 50 to facilitate packaging and isolation of those components within the pressure vessel housing 12.

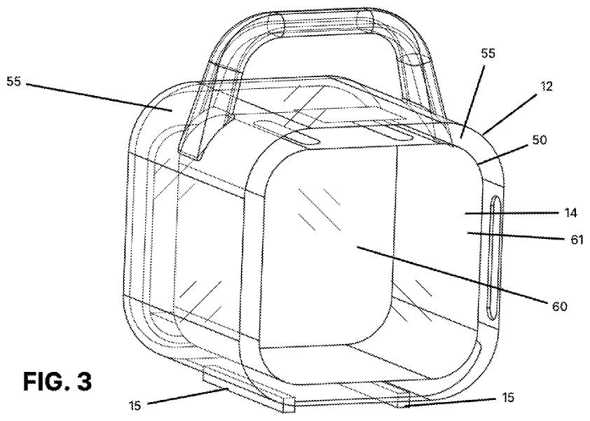

FIG. 3 shows a hyperbaric chamber 60 including a pressure vessel housing 12 that defines an exterior structural enclosure. The pressure vessel housing 12 is supported on a supporting surface by support feet 15, which may be implemented as spaced apart load-bearing members coupled to a lower portion of the pressure vessel housing 12.

In the illustrated configuration, an inner vessel housing 50 is disposed within the pressure vessel housing 12 and defines an inner space of the hyperbaric chamber 60 configured to receive storage trays. The pressure vessel housing 12 further defines a compression component chamber 55, shown as a volume within the pressure vessel housing 12 that is segregated from at least a portion of the inner vessel housing 50. The compression component chamber 55 may be configured to house pressurization-related components (e.g., a compressor and/or distribution manifold) such that the components are contained within the pressure vessel housing 12 while remaining outside the inner space of the inner vessel housing 50.

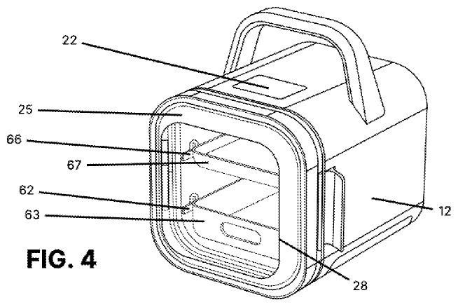

FIG. 4 shows a hyperbaric chamber including a pressure vessel housing 12 defining an interior space accessible through an opening at a front end of the pressure vessel housing 12. A control panel 22 is disposed on an exterior surface of the pressure vessel housing 12 and may be used to present operating information and/or receive user inputs for operation of the chamber.

A structural door 25 is positioned at the opening and is configured to close the interior space. The structural door 25 includes a translucent panel 28 that provides optical transmission through at least a portion of the structural door 25 to permit viewing into the interior space when the structural door 25 is in a closed position. In various implementations, the structural door 25 and/or the translucent panel 28 may be formed from an optically transparent polymeric material (e.g., polycarbonate, acrylic, polymethyl methacrylate (PMMA), polyethylene terephthalate (PET), polyethylene terephthalate glycol-modified (PETG), polysulfone, or transparent polyurethane), glass, laminated glass, or combinations thereof.

Within the interior space, the pressure vessel housing 12 includes first grooved tracks 62 configured to receive and guide a first storage tray 63 between an inserted position and a withdrawn position. The pressure vessel housing 12 further includes second grooved tracks 66 configured to receive and guide a second storage tray 67 between an inserted position and a withdrawn position. The first grooved tracks 62 and the second grooved tracks 66 may be positioned at different elevations within the interior space to support multiple storage trays simultaneously, and the storage trays may be removable to permit cleaning, replacement, or reconfiguration.

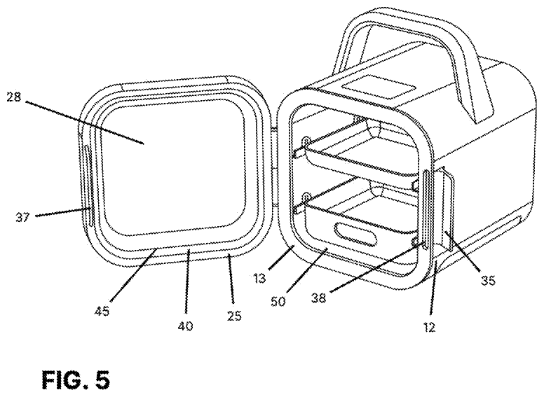

FIG. 5 shows a pressure vessel housing 12 supported by a vessel support 13 and having an access opening closable by a structural door 25. The structural door 25 includes a translucent panel 28 configured to provide optical transmission through the structural door 25 to permit viewing into an interior region of the pressure vessel housing 12. In some embodiments, the translucent panel 28 and/or the structural door 25 may be formed from an optically transparent material such as polycarbonate, acrylic (e.g., polymethyl methacrylate), tempered glass, laminated glass, polyethersulfone, polysulfone, polyethylene terephthalate glycol (PETG), or another transparent or translucent polymeric or glass material.

The structural door 25 carries a gasket 40 disposed to interface with a gasket recess 45 defined within the interior of structural door 25, with the gasket 40 arranged to form a seal between the structural door 25 and the pressure vessel housing 12 when the structural door 25 is in a closed position. The pressure vessel housing 12 includes an inner vessel housing 50 defining an interior volume, and a u-bar recess 38 positioned adjacent the access opening to receive a u-bar 37 when the structural door 25 is closed. A compression-actuated latching mechanism 35 is coupled to the pressure vessel housing 12 and is configured to engage the u-bar 37 (e.g., by drawing the u-bar 37 toward the u-bar recess 38) to compress the gasket 40 and retain the structural door 25 in the closed position during pressurization.

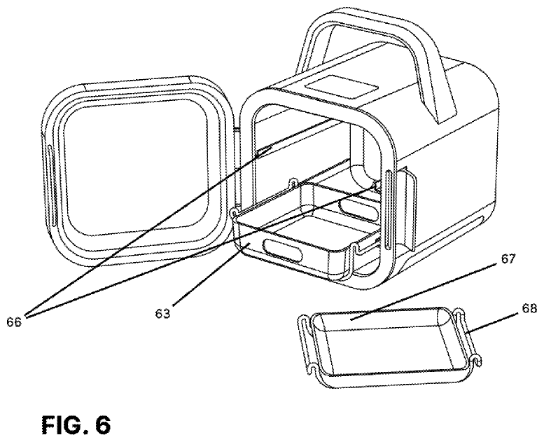

FIG. 6 shows an interior-access configuration of a hyperbaric chamber in which first storage tray 63 is positioned within an inner space and is supported for sliding movement relative to the chamber. In the illustrated arrangement, second grooved tracks 66 are disposed along opposed interior side regions and define a guided path configured to receive and laterally constrain an associated tray during insertion and withdrawal, thereby providing a set of grooved tracks on either side of the inner space capable of receiving a storage tray.

FIG. 6 further shows second storage tray 67 as a removable tray separable from the chamber housing and configured to be received by the internal track structure. Second storage tray rails 68 are coupled to second storage tray 67 and provide engagement features configured to ride within second grooved tracks 66, thereby supporting the tray while permitting movement along the tracks. In some implementations, the geometry, cross-section, and spacing of second grooved tracks 66 and/or second storage tray rails 68 may be selected to provide a sliding fit, a detented fit, or a captured fit while maintaining removability of second storage tray 67 for loading, cleaning, or interchange with another tray configuration.

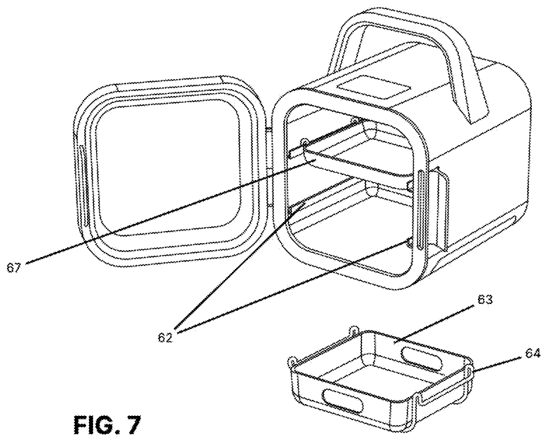

FIG. 7 shows an example arrangement for supporting one or more removable trays within an interior space of a hyperbaric chamber. In the illustrated embodiment, first grooved tracks 62 are disposed along opposing interior side regions of the chamber and define longitudinal guide features configured to receive corresponding tray support members. The first grooved tracks 62 may extend in a direction generally parallel to an insertion/removal direction through an access opening such that a tray may be translated into and out of the inner space while being laterally constrained by the grooves. Although depicted as a pair of opposed grooves, the first grooved tracks 62 may be implemented as continuous channels, segmented channels, or other grooved profiles configured to interface with a tray support feature.

FIG. 7 further shows a first storage tray 63 configured for placement within the inner space. The first storage tray 63 includes first storage tray rails 64 coupled to, formed with, or otherwise supported by the first storage tray 63, wherein the first storage tray rails 64 engage the first grooved tracks 62 to support the first storage tray 63 at a selected height and to guide sliding movement along the first grooved tracks 62. The first storage tray rails 64 may be implemented as rods, runners, flanges, or other rail geometries sized and shaped to be received in the first grooved tracks 62 with a clearance fit, an interference fit, or a fit that permits controlled sliding.

In the illustrated embodiment, a second storage tray 67 is shown positioned within the chamber above the first storage tray 63, demonstrating that multiple trays may be concurrently supported by track sets at different elevations. The second storage tray 67 may be received by a second set of grooved tracks on either side of the inner space, or may be received by another portion of the first grooved tracks 62 where the first grooved tracks 62 include multiple vertically spaced grooves, thereby enabling multiple tray positions within the chamber.

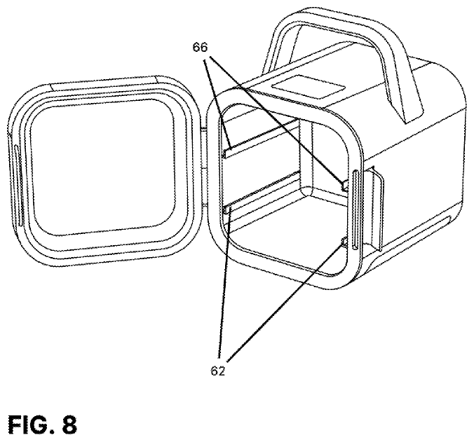

FIG. 8 shows a perspective view of a hyperbaric chamber with a door in an open position to expose an inner space of a pressure vessel. Within the inner space, first grooved tracks 62 are disposed along opposing side regions and extend in a longitudinal direction to support sliding insertion and removal of a storage tray along a first elevation. Second grooved tracks 66 are disposed along the opposing side regions at a different elevation relative to first grooved tracks 62, thereby providing a second set of track interfaces for receiving a storage tray at a second elevation.

In operation, first grooved tracks 62 and second grooved tracks 66 may each define paired, generally opposed grooves sized to capture lateral edge portions of a storage tray to constrain motion of the storage tray during translation into and out of the inner space. The grooved tracks may be formed as integrally molded channels of an interior liner, as attached rails, or as machined or formed grooves in a structural wall, and may include straight segments and/or locally curved or tapered lead-in regions to facilitate tray engagement. Although shown as two sets, first grooved tracks 62 and second grooved tracks 66 may be implemented with various groove cross-sections, spacing, and lengths to accommodate different tray geometries and load conditions while providing multiple storage positions within the hyperbaric chamber.

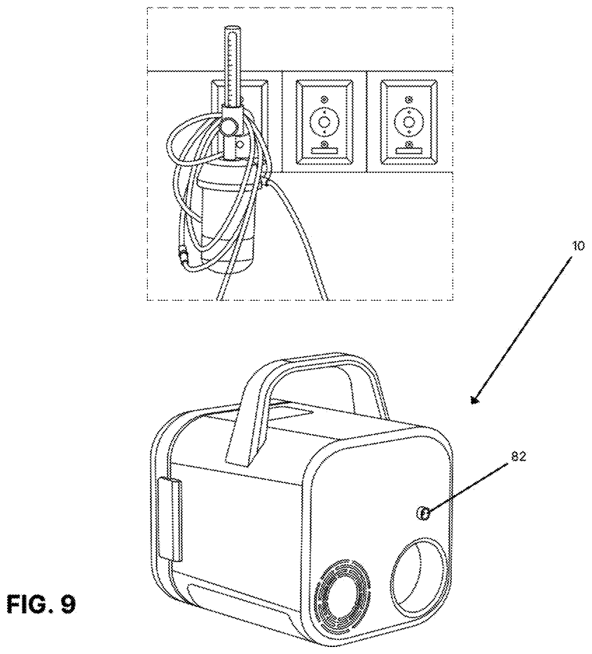

FIG. 9 shows a hyperbaric apparatus 10 including a housing configured to be positioned adjacent to, or integrated with, a hyperbaric chamber. The hyperbaric apparatus 10 may enclose one or more pressurization and/or gas-handling components, and may be configured as a portable module, as shown, including an external handle to facilitate manual transport and positioning relative to the chamber or other system components.

In the illustrated embodiment, the hyperbaric apparatus 10 includes a high pressure oxygen inlet port 82 disposed on an exterior surface of the housing. The high pressure oxygen inlet port 82 is configured to receive oxygen from an external high-pressure source via a coupling interface (e.g., a hose adaptor and/or other connector structure) and to communicate the received oxygen into internal fluid circuitry of the hyperbaric apparatus 10 for delivery to an interior of the hyperbaric chamber. The high pressure oxygen inlet port 82 may be implemented as a bulkhead-mounted fitting, may include one or more valves and/or regulators upstream or downstream of the port, and may be arranged to couple to different oxygen supply formats in different embodiments (e.g., cylinders, concentrators, or facility oxygen lines).

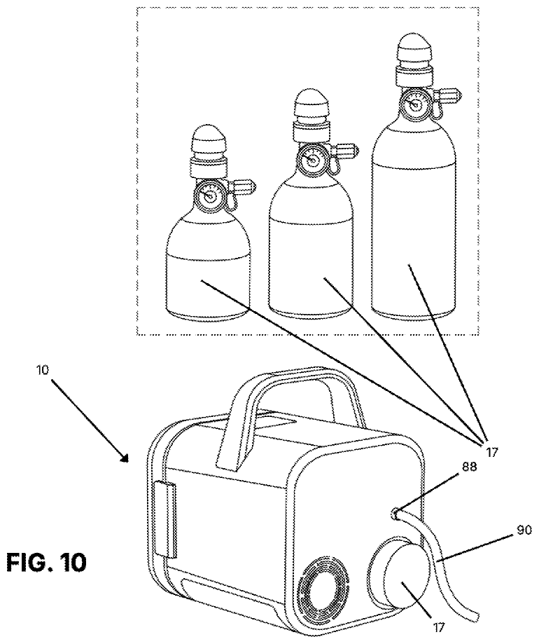

FIG. 10 shows a hyperbaric apparatus 10 configured to receive oxygen from an auxiliary oxygen tank 17. In the illustrated configuration, the hyperbaric apparatus 10 includes a connection interface at an exterior portion of the hyperbaric apparatus 10 for coupling to the auxiliary oxygen tank 17 to supply oxygen to the hyperbaric apparatus 10 during operation.

As shown in FIG. 10, the auxiliary oxygen tank 17 is fluidly coupled to the hyperbaric apparatus 10 via a hose adaptor 88 and a first hose 90. The hose adaptor 88 may be configured to provide a mechanical and fluid connection between the auxiliary oxygen tank 17 and the first hose 90, with the first hose 90 extending between the hose adaptor 88 and the hyperbaric apparatus 10 to inject oxygen from the auxiliary oxygen tank 17 to the hyperbaric apparatus 10. In some implementations, the auxiliary oxygen tank 17 may be selected from a plurality of available tank sizes or form factors, and the hose adaptor 88 (which may optionally be fitted with a spark arrestor) and/or first hose 90 may be correspondingly selected to provide compatible coupling to the auxiliary oxygen tank 17 (which may also optionally be fitted with a spark arrestor) while maintaining fluid communication with the hyperbaric apparatus 10.

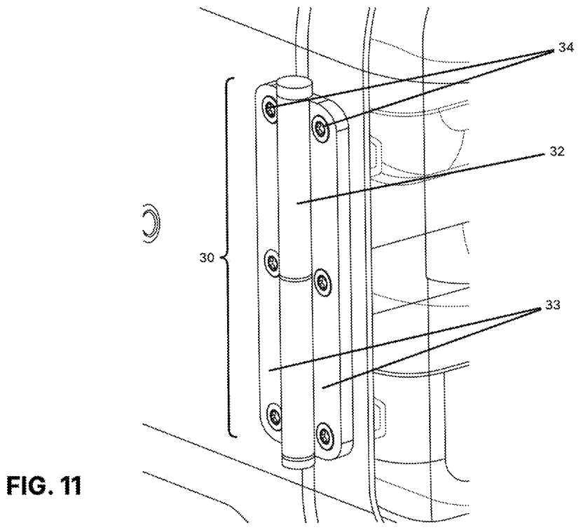

FIG. 11 shows a hinge assembly 30 configured to pivotally couple a structural door to a portion of a pressure vessel of a hyperbaric chamber. The hinge assembly 30 includes a central barrel 32 extending along a hinge axis and providing a rotational interface between opposing hinge attachment leaves 33. The hinge attachment leaves 33 are positioned on respective sides of the central barrel 32 and provide mounting surfaces for coupling the hinge assembly 30 to adjacent chamber structures, such as a door frame and a door panel, to support opening and closing movement about the hinge axis.

As shown, fasteners 34 secure the hinge attachment leaves 33 to the adjacent chamber structures. The fasteners 34 may include threaded fasteners, bolts, screws, pins, rivets, or other mechanical retainers, and may be used with washers, inserts, or embedded mounting features depending on implementation. The central barrel 32 and/or hinge attachment leaves 33 may be formed from metal, polymeric material, or composite material; in some implementations, materials may include stainless steel, aluminum alloys, titanium alloys, brass, clear polycarbonate, opaque polycarbonate, acrylic, polyethylene terephthalate glycol (PETG), polyetheretherketone (PEEK), nylon, fiber-reinforced polymers, or combinations thereof, with selection based on pressure rating, corrosion exposure, and transparency targets for surrounding door components.

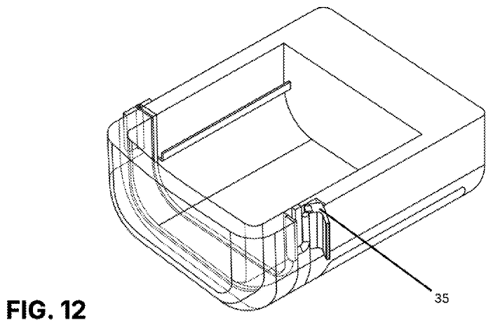

FIG. 12 shows a portion of a hyperbaric chamber including a compression-actuated latching mechanism 35 disposed adjacent an interface between a structural door and a pressure vessel. In the illustrated configuration, the compression-actuated latching mechanism 35 is positioned to engage mating structure across the interface to retain the structural door in a closed position relative to the pressure vessel, while permitting release responsive to a change in compressive loading applied at the interface.

In some implementations, the compression-actuated latching mechanism 35 may include one or more latch members, keepers, springs, cams, wedges, detents, or compliant elements arranged such that an increase in chamber pressure contributes to maintaining engagement, and a reduction in chamber pressure enables disengagement. The compression-actuated latching mechanism 35 may be configured for manual actuation, assisted actuation, or automatic actuation, and may be implemented as a single latch assembly or a plurality of latch assemblies distributed along a perimeter region of the structural door and/or the pressure vessel.

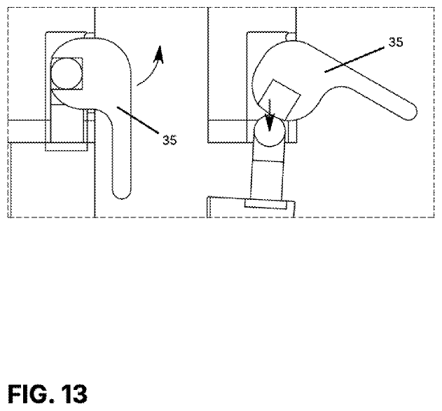

FIG. 13 shows a compression-actuated latching mechanism 35 in respective closed and open operating positions. In the closed position (left view), the compression-actuated latching mechanism 35 is rotated into an engaged orientation in which the mechanism bears against an adjacent structure and retains a closure interface in a latched state. The indicated rotational direction corresponds to moving the compression-actuated latching mechanism 35 from the engaged orientation toward a release orientation.

In the open position (right view), the compression-actuated latching mechanism 35 is rotated away from the engaged orientation, permitting separation of the latched interface. In operation, the compression-actuated latching mechanism 35 may translate an applied user input into a compressive load at the latch interface to promote sealing and retention when closed, and may reduce or remove the compressive load when opened to permit release. The geometry, pivot location, and bearing surfaces of the compression-actuated latching mechanism 35 may be configured to provide a selected mechanical advantage and/or a selected amount of compression over a range of handle travel, including implementations in which the mechanism is operable by manual actuation or by an assisted actuator.

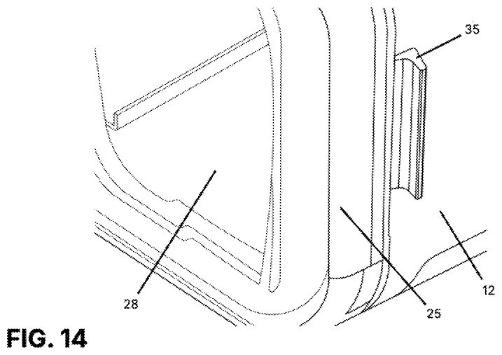

FIG. 14 shows a portion of a hyperbaric chamber including a pressure vessel housing 12 and a structural door 25 coupled to the pressure vessel housing 12 at an access opening. The structural door 25 includes a translucent panel 28 configured to provide optical transmission through the structural door 25 to permit visual observation across the door boundary while the structural door 25 is in a closed condition.

In the illustrated configuration, a compression-actuated latching mechanism 35 is disposed adjacent an interface between the structural door 25 and the pressure vessel housing 12. The compression-actuated latching mechanism 35 is configured to retain the structural door 25 in the closed condition by applying a compressive load to maintain sealing engagement between the structural door 25 and the pressure vessel housing 12, and to release the structural door 25 responsive to an actuation input that reduces the compressive load.

The translucent panel 28 may be implemented as an optically transparent window portion of the structural door 25. For example, the translucent panel 28 and/or the structural door 25 may comprise polycarbonate, acrylic, glass, tempered glass, laminated glass, polyurethane, polyethylene, polypropylene, polysulfone, polyetherimide, or combinations thereof, with thickness and reinforcement selected based on a target pressure rating for the pressure vessel housing 12 and a target field-of-view through the translucent panel 28.

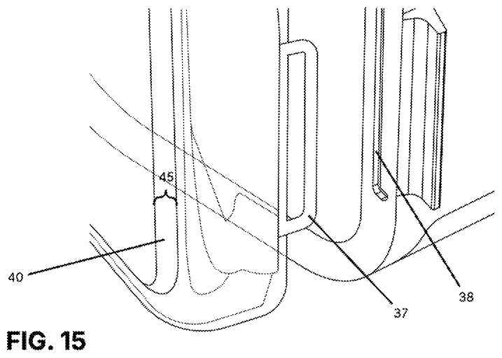

FIG. 15 shows a partial perspective detail of an interface region of a hyperbaric chamber, depicting a sealing arrangement between adjoining structural components. A gasket 40 is disposed along a perimeter portion of the interface and is seated within a gasket recess 45 formed in a mating surface. The gasket recess 45 defines a channel that positions the gasket 40 during assembly and, in operation, the gasket 40 provides a seal along the interface to inhibit leakage of pressurized gas from the pressure vessel.

FIG. 15 further shows a u-bar 37 positioned adjacent the sealing arrangement. The u-bar 37 is received within a u-bar recess 38 that is formed in a corresponding portion of the chamber structure. In various implementations, the u-bar 37 may function as a reinforcement, alignment member, edge protector, or handle feature, and the u-bar recess 38 may be configured to locate the u-bar 37 relative to the gasket 40 such that the u-bar 37 does not interfere with seating of the gasket 40 in the gasket recess 45. The gasket 40 and gasket recess 45 may extend continuously around a perimeter of an access opening or may be provided along selected segments, and the u-bar 37 may extend along a portion of the perimeter or along an edge region of a structural door or adjacent frame. In the event that high pressure is required of the hyperbaric apparatus 10, components with additional strength or additional reinforcement components may be added.

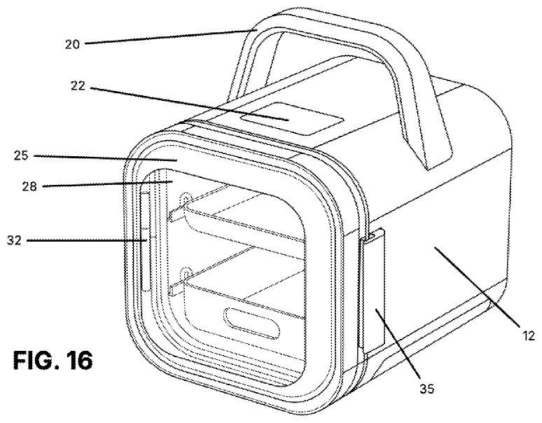

FIG. 16 shows a hyperbaric chamber including a pressure vessel housing 12 defining an interior volume. The pressure vessel housing 12 carries a handle 20 disposed on an upper portion of the pressure vessel housing 12 to support carrying and repositioning of the chamber. A control panel 22 is disposed on an exterior surface of the pressure vessel housing 12 and may provide user interface functions including displaying operating conditions and receiving user input for operation of the chamber.

FIG. 16 further shows a structural door 25 at an end opening of the pressure vessel housing 12, the structural door 25 being configured to close the interior volume for pressurization. The structural door 25 includes a translucent panel 28 that provides optical access through the structural door 25 to the interior volume. In various embodiments, the translucent panel 28 and/or the structural door 25 may be formed from a polymeric material (e.g., polycarbonate), an acrylic material, a glass material (including tempered or laminated glass), or another optically transmissive material selected based on pressure rating and impact performance.

Within the interior volume, a central barrel 32 extends along a longitudinal axis of the chamber and may define a patient space and/or support internal components. A compression-actuated latching mechanism 35 is coupled adjacent the structural door 25 and is configured to secure the structural door 25 to the pressure vessel housing 12 by applying a compressive load to a seal interface when the structural door 25 is closed, thereby facilitating a pressure-retaining closure while permitting release for access to the central barrel 32. It is reiterated that additional reinforcement components may be used or components with additional strength may be used if high pressures are required.

### Benefits

The present invention offers the advantages of being miniaturized and is thus easily portable and may be moved between rooms easily in a clinical setting. The nested dual chamber aspect allows the apparatus to be very small, while providing for additional safety advantages over single chamber systems safety or dual chamber systems that are side by side and not configured as nesting chambers. The inclusion of dual flashback arrestors provide additional safety measures that are not provided by current systems.

As can be understood, another major benefit of the chamber of the present disclosure is that the patient is not required to be present in order to enter the chamber. The chamber may be used in advance on the tissue that needs to be hyper-oxygenated.

The dual nested chamber configuration, in which inner vessel housing 50 is disposed within pressure vessel housing 12 to define hyperbaric chamber 60 and a surrounding compression component chamber 55, provides a compact packaging architecture that may increase portability and placement flexibility for point-of-care use while separating a pressurized oxygen-processing volume for biological materials from volumes that may contain pressurization and gas-handling components, thereby reducing exposure of such components to elevated oxygen partial pressure and facilitating use of materials and layouts selected for oxygen-service conditions; additionally, the intervening outer space may function as a barrier region that can be configured to capture or dilute leakage from the hyperbaric chamber 60 before discharge to ambient, and may provide a location for routing inlet manifold 80, distribution manifold 75, condensate drain line 78, and associated fittings (e.g., bulkhead fitting 85, hose adaptor 88) in a manner that reduces external hose clutter and supports integrated connection to either facility oxygen via high pressure oxygen inlet port 82 or an auxiliary oxygen tank 17 received within auxiliary oxygen tank recess 18, while also enabling the pressure vessel housing 12 to provide impact protection and handling features (e.g., handle 20, support feet 15) without increasing the internal treatment volume required for tissue processing.

It will be appreciated by those skilled in the art that while the miniaturized hyperbaric oxygen chamber has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

1. A hyperbaric apparatus comprising:
a pressure vessel housing defining an internal volume and having a primary access opening;
a structural door pivotably coupled to the pressure vessel housing at a first lateral edge of the structural door;
a compression-actuated latching mechanism disposed at a second lateral edge of the structural door opposite the first lateral edge and configured to secure the structural door in a closed position;
wherein a sealing interface is disposed between the pressure vessel housing and the structural door, the sealing interface comprising a rubber gasket seated within a circumferential gasket recess of the structural door and configured to form a hermetic seal upon engagement of the compression-actuated latching mechanism;
an inner vessel housing having a secondary access opening provided within the pressure vessel housing and coupled thereto by way of a vessel support, wherein the inner vessel housing defines a hyperbaric chamber;
wherein the vessel support comprises a perimeter panel extending between the primary access opening of the pressure vessel housing and the secondary access opening of the inner vessel housing and configured to mechanically couple the inner vessel housing within the pressure vessel housing and define a compression component chamber between the pressure vessel housing and the inner vessel housing; and,
the compression component chamber further includes a high-pressure oxygen inlet port configured to receive an oxygen hose and in fluid communication with an interior of the hyperbaric chamber.

2. The hyperbaric apparatus of claim 1, wherein the pressure vessel housing further includes a handle.

3. The hyperbaric apparatus of claim 1, wherein the pressure vessel housing further includes a pair of support feet.

4. The hyperbaric apparatus of claim 1, wherein the pressure vessel housing further includes a control panel capable of measuring an oxygen concentration, an oxygen pressure or both of the hyperbaric chamber.

5. The hyperbaric apparatus of claim 1, wherein the hyperbaric chamber includes a first pair of grooved tracks on either side of an interior of the hyperbaric chamber and capable of receiving a first storage tray.

6. The hyperbaric apparatus of claim 5, wherein the hyperbaric chamber includes a second pair of grooved tracks on either side of the interior of the hyperbaric chamber and above the first pair of grooved tracks and capable of receiving a second storage tray.

7. The hyperbaric apparatus of claim 6, wherein the first storage tray further includes a pair of first storage tray rails configured to slide along the first pair of grooved tracks and wherein the second storage tray further includes a pair of second storage tray rails configured to slide along the second pair of grooved tracks.

8. The hyperbaric apparatus of claim 1, wherein the pressure vessel includes a recess capable of receiving an auxiliary oxygen canister.

9. The hyperbaric apparatus of claim 1, wherein the high-pressure oxygen port further includes a hose adaptor capable of receiving a high-pressure oxygen tank; the hose adapter in communication with a bulkhead fitting in communication with an inlet manifold that is in communication with the interior of the hyperbaric chamber.

10. The hyperbaric apparatus of claim 1, wherein the structural door is pivotably coupled to the pressure vessel housing at the first lateral edge of the structural door by way of a hinge assembly that includes a central barrel, hinge attachment leaves, and a plurality of fasteners.

11. The hyperbaric apparatus of claim 1, wherein the structural door further includes a u-bar on the second lateral edge and wherein the pressure vessel housing further includes a u-bar recess capable of receiving the u-bar.

12. The hyperbaric apparatus of claim 1, wherein the structural door is optically transparent.

13. The hyperbaric apparatus of claim 12, wherein the structural door comprised of a clear poylcarbonate material.

14. The hyperbaric apparatus of claim 1, wherein the pressure vessel housing, the inner vessel housing, the first storage tray, and the second storage tray are all comprised of rigid plastic.

15. A hyperbaric apparatus comprising:
a pressure vessel housing defining an internal volume and having a primary access opening;
a structural door pivotably coupled to the pressure vessel housing at a first lateral edge of the structural door;
a compression-actuated latching mechanism disposed at a second lateral edge of the structural door opposite the first lateral edge and configured to secure the structural door in a closed position;
wherein a sealing interface is disposed between the pressure vessel housing and the structural door, the sealing interface comprising a rubber gasket seated within a circumferential gasket recess of the structural door and configured to form a hermetic seal upon engagement of the compression-actuated latching mechanism;
an inner vessel housing having a secondary access opening and provided within the pressure vessel housing and coupled thereto by way of a vessel support, wherein the inner vessel housing defines a hyperbaric chamber;
wherein the vessel support comprises a perimeter panel extending between the the primary access opening of the pressure vessel housing and the secondary access opening of the inner vessel housing and configured to mechanically couple the inner vessel housing within the pressure vessel housing and define a compression component chamber between the pressure vessel housing and the inner vessel housing;
the compression component chamber further includes a high-pressure oxygen inlet port configured to receive an oxygen hose and in fluid communication with an interior of the hyperbaric chamber; and,
a compressor capable of compressing ambient oxygen and in fluid communication with a distribution manifold, which is in fluid communication with the interior of the hyperbaric chamber.

16. The hyperbaric apparatus of claim 15, wherein the compressor and distribution manifold is located within the compression component chamber.

17. The hyperbaric apparatus of claim 16, wherein the distribution manifold further includes filtration, moisture removal, and heat exchange capability.

18. The hyperbaric apparatus of claim 17, wherein the distribution manifold is in communication with a condensate drain line capable of draining or purging condensate from the distribution manifold.

19. A hyperbaric apparatus comprising:
a pressure vessel housing defining an internal volume and having a primary access opening;
a structural door pivotably coupled to the pressure vessel housing at a first lateral edge of the structural door;
a compression-actuated latching mechanism disposed at a second lateral edge of the structural door opposite the first lateral edge and configured to secure the structural door in a closed position;
an inner vessel housing having a secondary access opening and provided within the pressure vessel housing and coupled thereto by way of a vessel support, wherein the inner vessel housing defines a hyperbaric chamber;
wherein the vessel support comprises a perimeter panel extending between the primary access opening of the pressure vessel housing and the secondary access opening of the inner vessel housing and configured to mechanically couple the inner vessel housing within the pressure vessel housing and define a compression component chamber between the pressure vessel housing and the inner vessel housing; and,
the compression component chamber further includes a high-pressure oxygen inlet port configured to receive an oxygen hose and in fluid communication with an interior of the hyperbaric chamber.

20. The hyperbaric apparatus of claim 19, wherein the compression component chamber further includes a compressor capable of compressing ambient oxygen and in fluid communication with a distribution manifold, which is in fluid communication with the interior of the hyperbaric chamber.
